(19) United States
(12) Patent Application Publication
(10) Pub. No.: US 2023/0259894 A1
(43) Pub. Date: Aug. 17, 2023

(54) COMPUTER, CAR SHARING SYSTEM, AND CAR SHARING METHOD

(71) Applicant: TOYOTA JIDOSHA KABUSHIKI KAISHA, Toyota-shi Aichi-ken (JP)

(72) Inventors: Ryosuke KOBAYASHI, Nagakute-shi Aichi-ken (JP); Tomokazu MAYA, Nagoya-shi Aichi-ken (JP); Tsuyoshi OKADA, Nagoya-shi Aichi-ken (JP); Hiromitsu FUJII, Kariya-shi Aichi-ken (JP)

(73) Assignee: TOYOTA JIDOSHA KABUSHIKI KAISHA, Toyota-shi Aichi-ken (JP)

(21) Appl. No.: 17/982,707

(22) Filed: Nov. 8, 2022

(30) Foreign Application Priority Data
Jan. 28, 2022 (JP) 2022-011735

(51) Int. Cl. G06Q 10/00; G06Q 30/02

(52) U.S. Cl. CPC G06Q 10/20; G06Q 30/0283

(57) ABSTRACT

A computer is configured to, in a case where maintenance of a component is executed in one vehicle used by a plurality of users, decide a payment ratio of each user for a cost of the maintenance based on a kind of the component subjected to the maintenance and a usage mode of the vehicle of each user.

### CROSS-REFERENCE TO RELATED APPLICATION

This application claims priority to Japanese Patent Application No. 2022-011735 filed on Jan. 28, 2022, incorporated herein by reference in its entirety.

### BACKGROUND

### 1. Technical Field

The present disclosure relates to a computer, a car sharing system, and a car sharing method.

### 2. Description of Related Art

Japanese Unexamined Patent Application Publication No. 2015-138395 (JP 2015-138395 A) discloses a technique of calculating a cost of maintenance (labor cost and cost of goods needed for work) in a transportation system in which a vehicle travels on a predetermined track, such as a railroad or a bus.

### SUMMARY

In recent years, it has been proposed to effectively utilize one vehicle by sharing one vehicle with a plurality of users. In a form of long-term car sharing for one vehicle, it is conceivable that each user pays a cost of the maintenance in a case where the maintenance (for example, inspection, repair, or replacement) of a component mounted on the vehicle is executed.

However, it is difficult to decide a payment ratio of each user for the maintenance cost through discussions between the users. In addition, it is not always fair to decide the payment ratio for the maintenance cost by simple division by the number of people. For example, it is not fair that a user who uses the vehicle in a mode that accelerates the deterioration of the component and a user who uses the vehicle in a mode that does not deteriorate the component pay the same cost.

The present disclosure is to fairly decide the payment ratio of each user for the cost of the maintenance in a case where the maintenance of the component is executed in one vehicle used by the users.

A first aspect of the present disclosure relates to a computer. The computer is configured to, in a case where maintenance of a component is executed in one vehicle used by a plurality of users, decide a payment ratio of each user for a cost of the maintenance based on a kind of the component subjected to the maintenance and a usage mode of the vehicle of each user.

With the computer described above, in a case where the maintenance of the component is executed in one vehicle used by the users, the payment ratio of each user for the cost of the maintenance is decided based on the kind of the component subjected to the maintenance and the usage mode of the vehicle of each user. With such a computer, it is possible to fairly decide the cost payment ratio for each user.

The computer may include a processor and a storage device. The storage device may be configured to store cost payment information indicating a relationship between a plurality of component categories, a plurality of use categories, and a cost payment ratio. The processor may be configured to acquire the cost payment ratio of each user from a component category to which the kind of the component subjected to the maintenance belongs among the component categories and a use category to which a use for the vehicle of each user belongs among the use categories, and decide the payment ratio of each user for the cost of the maintenance by using the acquired cost payment ratio of each user. With such a configuration, it is possible to easily and accurately decide the cost payment ratio for each user.

The component categories may include two or more component categories selected from the group consisting of a first component category related to an interior component, a second component category related to a drive system component, a third component category related to a suspension, and a fourth component category related to a power storage device. The use categories may include two or more use categories selected from the group consisting of a first use category related to an office use, a second use category related to a passenger transportation use, a third use category related to a physical distribution use, and a fourth use category related to a medical use.

With the configuration described above, it is easy to fairly decide the cost payment ratio for each user. For example, in a case where the passenger transportation use and the office use are compared, each of the drive system component and the suspension-related component tends to be more easily deteriorated in the passenger transportation use, and the component of the power storage device tends to be more easily deteriorated in the office use. In a case where the passenger transportation use and the physical distribution use are compared, all of the interior component, the drive system component, the suspension-related component, and the component of the power storage device tend to be more easily deteriorated in the physical distribution use. In a case where the passenger transportation use and the medical use are compared, each of the drive system component and the suspension-related component tends to be more easily deteriorated in the passenger transportation use, and the component of the power storage device tends to be more easily deteriorated in the medical use. In a case where the office use and the medical use are compared, all of the drive system component, the suspension-related component, and the component of the power storage device tend to be more easily deteriorated in the medical use.

The storage device may be configured to further store user information indicating a usage time of the vehicle of each user. The processor may be configured to decide the payment ratio of each user for the cost of the maintenance by further using the usage time of the vehicle of each user indicated by the user information in addition to the cost payment ratio of each user indicated by the cost payment information. With such a configuration, it is easy to more fairly decide the cost payment ratio for each user.

The computer may be configured to, in a case where the maintenance of the component is executed in the vehicle, acquire a progress degree of deterioration of the component caused by the usage of the vehicle for each user, and decide the payment ratio of each user for the cost of the maintenance of the component by using the progress degree of deterioration of the component for each user. Even with such a configuration, it is easy to more fairly decide the cost payment ratio for each user.

A second aspect of the present disclosure relates to a car sharing system. The car sharing system includes any of the computers described above, and the vehicle shared by the users. The vehicle is a multipurpose vehicle configured to be customized in accordance with a use of the user by changing an interior component.

The car sharing system includes the computer described above. Therefore, with the car sharing system described above, it is possible to fairly decide the payment ratio of each user for the cost of the maintenance in a case where the maintenance of the component is executed in one vehicle used by the users. In addition, by adopting the multipurpose vehicle, it is easy to provide each user with a vehicle having equipment that meets the needs of each user.

Any of the vehicles described above may include a control device, an autonomous driving kit, and a vehicle control interface configured to mediate exchange of signals between the control device and the autonomous driving kit. The autonomous driving kit may be configured to transmit a command for autonomous driving to the control device via the vehicle control interface. The control device may be configured to control the vehicle in accordance with the command from the autonomous driving kit. The control device may be configured to transmit a signal indicating a state of the vehicle to the autonomous driving kit via the vehicle control interface.

By adopting the autonomous driving kit, it is easy to provide each user with a vehicle equipped with equipment that meets the needs of each user. In addition, due to the presence of the vehicle control interface, it is easy to attach and detach the autonomous driving kit, and it is easy to execute the maintenance (inspection, repair, replacement, or the like) of the autonomous driving kit.

A third aspect of the present disclosure relates to a car sharing method including first provision processing, second provision processing, and decision processing described below.

In the first provision processing, the computer provides a vehicle to a first user. In the second provision processing, the computer provides the vehicle to a second user after the first user uses the vehicle. In the decision processing, in a case where maintenance of a component is executed in the vehicle, the computer decides a payment ratio of each user for a cost of the maintenance based on a kind of the component subjected to the maintenance and a usage mode of the vehicle of each user.

Similar to the computer described above, even with the car sharing method described above, it is possible to fairly decide the payment ratio of each user for the cost of the maintenance in a case where the maintenance of the component is executed in one vehicle used by the users.

According to the present disclosure, it is possible to fairly decide the payment ratio of each user for the cost of the maintenance in a case where the maintenance of the component is executed in one vehicle used by the users.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a schematic configuration of a vehicle according to an embodiment of the present disclosure;

FIG. 2 is a diagram showing details of the configuration of the vehicle shown in FIG. 1;

FIG. 3 is a flowchart showing a processing procedure of autonomous driving control according to the embodiment of the present disclosure;

FIG. 4 is a diagram for describing various components provided in the vehicle according to the embodiment of the present disclosure;

FIG. 5 is a diagram showing an appearance of the vehicle according to the embodiment of the present disclosure;

FIG. 6 is a diagram for describing a configuration of a computer according to the embodiment of the present disclosure;

FIG. 7 is a flowchart showing processing executed by the computer to manage one vehicle shared by a plurality of users in a car sharing method according to the embodiment of the present disclosure;

FIG. 8 is a flowchart for describing the details of processing related to maintenance shown in FIG. 7;

FIG. 9 is a diagram showing a modification example of user information and cost payment information shown in FIG. 6; and

FIG. 10 is a flowchart showing a modification example of the processing shown in FIG. 8.

### DETAILED DESCRIPTION OF EMBODIMENTS

In the following, an embodiment of the present disclosure will be described in detail with reference to the drawings. It should be noted that, in the drawings, the same or corresponding parts are designated by the same reference signs and the description thereof will not be repeated.

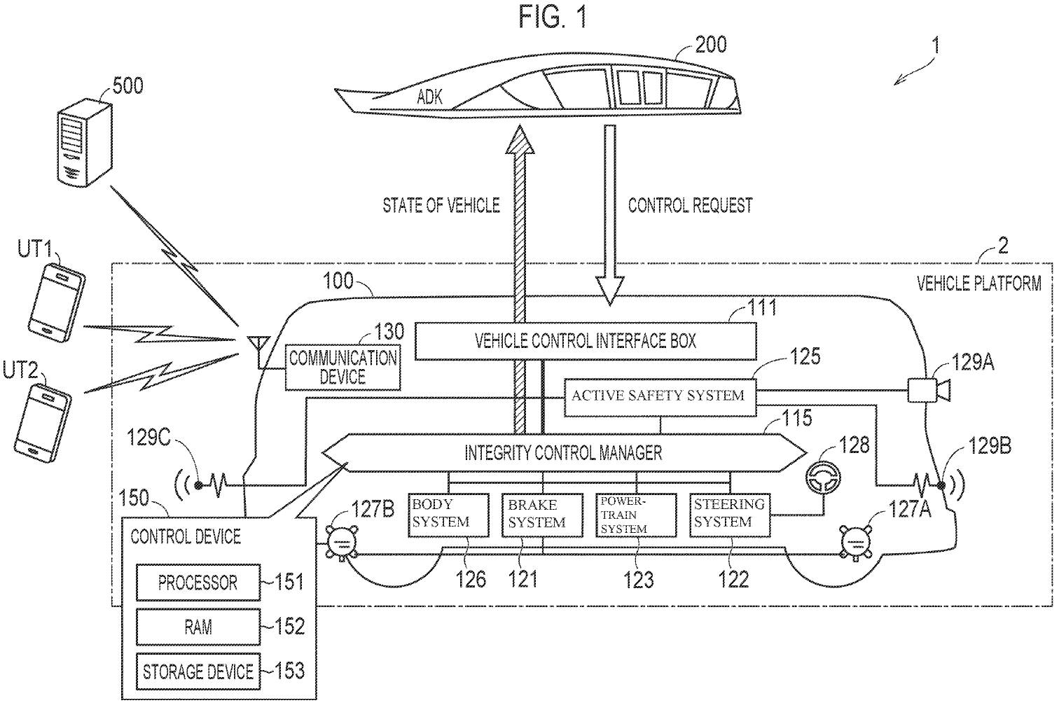

FIG. 1 is a diagram showing a schematic configuration of a vehicle according to the embodiment of the present disclosure. With reference to FIG. 1, a vehicle 1 includes an autonomous driving kit (hereinafter, referred to as “ADK”) 200 and a vehicle platform (hereinafter, referred to as “VP”) 2.

The VP 2 includes a control system of a base vehicle 100 and a vehicle control interface box (hereinafter, referred to as “VCIB”) 111 provided in the base vehicle 100. The VCIB 111 may communicate with the ADK 200 via an in-vehicle network, such as a controller area network (CAN). It should be noted that, although the base vehicle 100 and the ADK 200 are shown at separate positions in FIG. 1, the ADK 200 is actually attached to the base vehicle 100. In the present embodiment, the ADK 200 is attached to a rooftop of the base vehicle 100. It should be noted that an attachment position of the ADK 200 can be changed as appropriate.

The base vehicle 100 is, for example, a commercially available electrified vehicle (xEV). The xEV is a vehicle that uses electric power as all or part of a power source. In the present embodiment, a battery electric vehicle (BEV) is adopted as the base vehicle 100. It should be noted that the present disclosure is not limited to this, and the base vehicle 100 may be an xEV (HEV, PHEV, FCEV, or the like) other than the BEV. The number of wheels provided in the base vehicle 100 is, for example, four. It should be noted that the number of wheels provided in the base vehicle 100 is not limited to this, and may be three or five or more.

The control system of the base vehicle 100 includes, in addition to an integrity control manager 115, various systems and various sensors for controlling the base vehicle 100. The integrity control manager 115 controls various systems related to the operation of the base vehicle 100 in an integrated manner based on signals (sensor detection signals) from various sensors provided in the base vehicle 100.

In the present embodiment, the integrity control manager 115 includes a control device 150. The control device 150 includes a processor 151, a random access memory (RAM) 152, and a storage device 153. As the processor 151, for example, a central processing unit (CPU) can be adopted. The RAM 152 functions as a working memory that transitorily stores the data processed by the processor 151. The storage device 153 is configured to store the stored information. For example, the storage device 153 includes a read only memory (ROM) and a rewritable non-volatile memory. The storage device 153 stores information used in a program (for example, a map, a mathematical formula, and various parameters), in addition to the program. In the present embodiment, the processor 151 executes the program stored in the storage device 153 to execute various vehicle controls (for example, autonomous driving control in response to an instruction from the ADK 200). It should be noted that these pieces of processing may be executed by dedicated hardware (electronic circuit) instead of software. It should be noted that the number of processors provided in the control device 150 is optional, and the processor may be prepared for each predetermined control.

The base vehicle 100 includes a brake system 121, a steering system 122, a powertrain system 123, an active safety system 125, and a body system 126. These systems are controlled in an integrated manner by the integrity control manager 115. In the present embodiment, each system includes the computer. Moreover, the computer for each system communicates with the integrity control manager 115 via the in-vehicle network (for example, the CAN). In the following, the computer provided in each system is referred to as an “electronic control unit (ECU)”.

The brake system 121 includes a braking device provided in each wheel of the base vehicle 100, and an ECU that controls the braking device. In the present embodiment, a hydraulic disc brake device is adopted as the braking device. The base vehicle 100 includes wheel speed sensors 127A, 127B. The wheel speed sensors 127A are provided in front wheels of the base vehicle 100 and detect the rotation speed of the front wheels. The wheel speed sensors 127B are provided in rear wheels of the base vehicle 100 and detect the rotation speed of the rear wheels. The ECU of the brake system 121 outputs a rotation direction and the rotation speed of each wheel detected by the wheel speed sensors 127A, 127B to the integrity control manager 115.

The steering system 122 includes a steering device of the base vehicle 100, and an ECU that controls the steering device. The steering device includes, for example, a rack and pinion type electric power steering (EPS) in which a steering angle can be adjusted by an actuator. The base vehicle 100 includes a pinion angle sensor 128. The pinion angle sensor 128 detects a rotation angle (pinion angle) of a pinion gear coupled to a rotation shaft of the actuator constituting the steering device. The ECU of the steering system 122 outputs the pinion angle detected by the pinion angle sensor 128 to the integrity control manager 115.

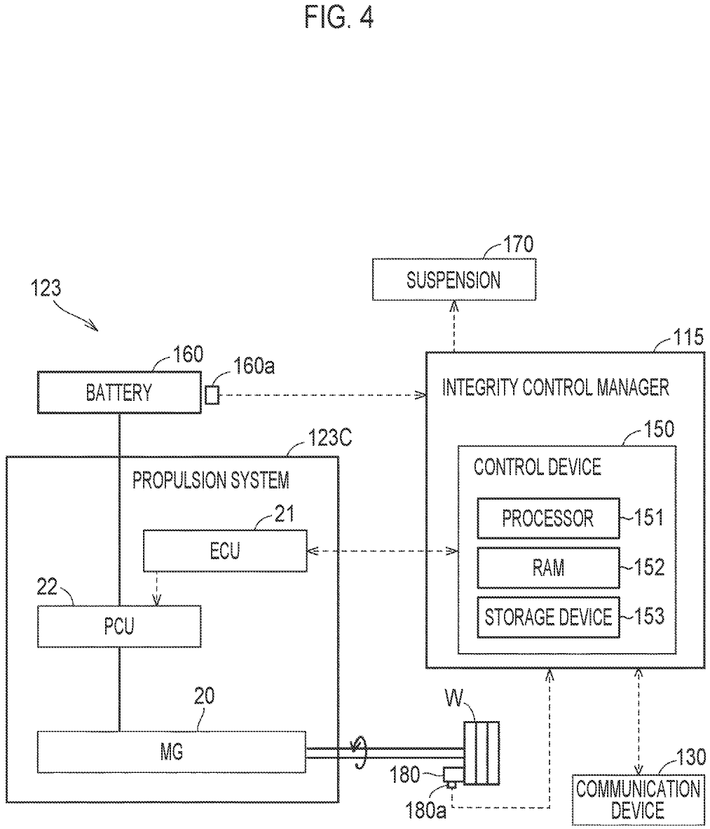

The powertrain system 123 includes an electric parking brake (EPB) provided in at least one of the wheels provided in the base vehicle 100, a P-Lock device provided in a transmission of the base vehicle 100, a shift device configured to select a shift range, a drive source of the base vehicle 100, and an ECU that controls each device provided in the powertrain system 123. The EPB is provided separately from the braking device described above, and puts the wheels into a fixed state by an electric actuator. For example, the P-Lock device puts a rotation position of an output shaft of the transmission into the fixed state by a parking lock pole that can be driven by the actuator. Although details will be described below, in the present embodiment, a motor that receives electric power supplied from a power storage device is adopted as the drive source of the base vehicle 100. The ECU of the powertrain system 123 outputs, to the integrity control manager 115, the presence or absence of fixation by each of the EPB and the P-Lock device, the shift range selected by the shift device, and a state of each of the power storage device and the motor (see FIG. 4 described below).

The active safety system 125 includes an ECU that determines the probability of collision with respect to the traveling vehicle 1. The base vehicle 100 includes a camera 129A and radar sensors 129B, 129C that detect peripheral situations including the front and rear of the vehicle 1. The ECU of the active safety system 125 determines whether or not there is the probability of collision by using the signals received from the camera 129A and the radar sensors 129B, 129C. In a case where the active safety system 125 determines that there is the probability of collision, the integrity control manager 115 outputs a braking command to the brake system 121 to increase a braking force of the vehicle 1. The base vehicle 100 according to the present embodiment includes the active safety system 125 from an initial stage (at the time of shipment). However, the present disclosure is not limited to this, and an active safety system that can be retrofitted to the base vehicle may be adopted.

The body system 126 includes body system components (for example, turn signals, a horn, and a windshield wiper), and an ECU that controls the body system components. The ECU of the body system 126 controls the body system components in response to a user operation in a manual mode, controls the body system components in response to the command received from the ADK 200 via the VCIB 111 and the integrity control manager 115 in an autonomous mode.

The vehicle 1 is configured to execute autonomous driving. The VCIB 111 functions as a vehicle control interface. In a case where the vehicle 1 travels by autonomous driving, the integrity control manager 115 and the ADK 200 exchange signals with each other via the VCIB 111, and the integrity control manager 115 executes traveling control (that is, autonomous driving control) by the autonomous mode in response to the command from the ADK 200. It should be noted that the ADK 200 can also be removed from the base vehicle 100. The base vehicle 100 can travel as a single base vehicle 100 by the user’s driving even in a state in which the ADK 200 is removed. In a case where the base vehicle 100 travels as a single base vehicle 100, the control system of the base vehicle 100 executes the traveling control in the manual mode (that is, traveling control in response to the user operation).

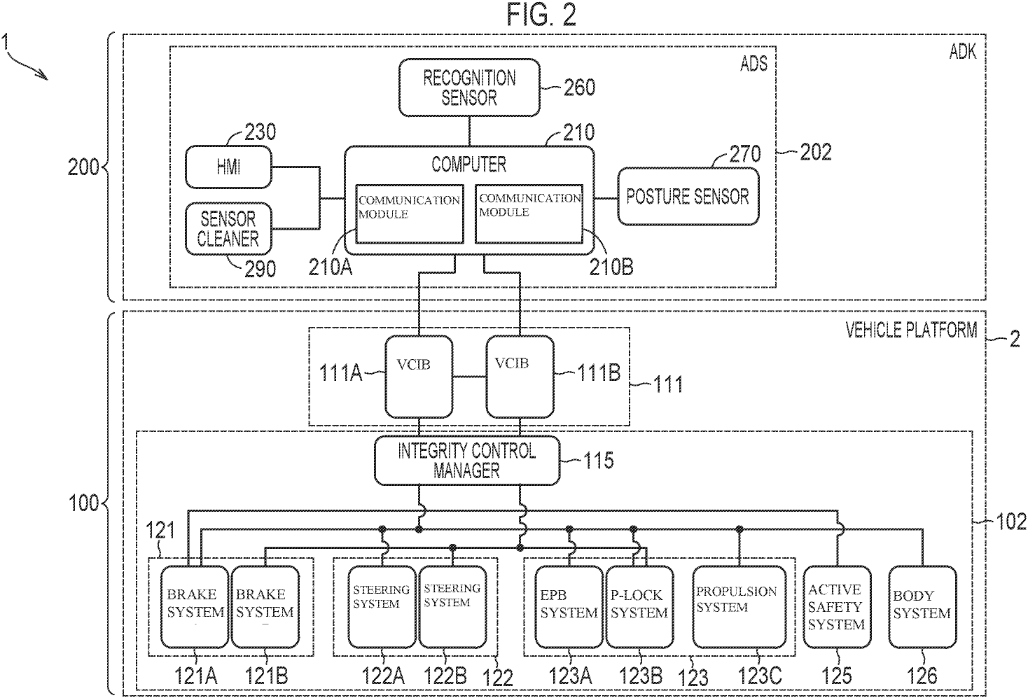

In the present embodiment, the ADK 200 exchanges signals with the VCIB 111 in accordance with an application program interface (API) that defines each signal to be communicated. The ADK 200 is configured to process various signals defined by the API described above. For example, the ADK 200 creates a traveling plan of the vehicle 1 and outputs various commands requesting control to cause the vehicle 1 to travel in accordance with the created traveling plan to the VCIB 111 in accordance with the API described above. In the following, each of the various commands described above output from the ADK 200 to the VCIB 111 is also referred to as an “API command”. In addition, the ADK 200 receives various signals indicating a state of the base vehicle 100 from the VCIB 111 in accordance with the API, and reflects the received state of the base vehicle 100 in the creation of the traveling plan. In the following, each of the various signals received by the ADK 200 from the VCIB 111 is also referred to as an “API signal”. Both the API command and the API signal correspond to the signals defined in the API described above. Details of the configuration of the ADK 200 will be described below (see FIG. 2).

The VCIB 111 receives various API commands from the ADK 200. In a case where the API command is received from the ADK 200, the VCIB 111 converts the API command into a signal format that can be processed by the integrity control manager 115. In the following, the API command converted into the signal format that can be processed by the integrity control manager 115 is also referred to as “control command”. In a case where the API command is received from the ADK 200, the VCIB 111 outputs the control command corresponding to the API command to the integrity control manager 115.

The control device 150 of the integrity control manager 115 transmits various signals (for example, a sensor signal or a status signal) indicating the state of the base vehicle 100 detected in the control system of the base vehicle 100 to the ADK 200 via the VCIB 111. The VCIB 111 sequentially receives the signals indicating the state of the base vehicle 100 from the integrity control manager 115. The VCIB 111 decides a value of the API signal based on the signals received from the integrity control manager 115. In addition, the VCIB 111 also converts the signal received from the integrity control manager 115 into an API signal format, as needed. Moreover, the VCIB 111 outputs the obtained API signal to the ADK 200. The API signal indicating the state of the base vehicle 100 is sequentially output from the VCIB 111 to the ADK 200 in real time.

In the present embodiment, a less versatile signal defined by, for example, an automobile manufacturer is exchanged between the integrity control manager 115 and the VCIB 111, and a more versatile signal (for example, a signal defined by an open API) is exchanged between the ADK 200 and the VCIB 111. The VCIB 111 converts the signals between the ADK 200 and the integrity control manager 115 to allow the integrity control manager 115 to execute the vehicle control in response to the command from the ADK 200. It should be noted that the function of the VCIB 111 is not limited to the function of converting the signals described above. For example, the VCIB 111 may make a predetermined determination and transmit signals based on the determination result (for example, signals for notification, instruction, and request) to at least one of the integrity control manager 115 and the ADK 200. Details of the configuration of the VCIB 111 will be described below (see FIG. 2).

The base vehicle 100 further includes a communication device 130. The communication device 130 includes various communication interfaces (I/Fs). The control device 150 is configured to execute communication with an external device of the vehicle 1 (for example, a mobile terminals UT1, UT2, and a server 500 described below) via the communication device 130. The communication device 130 includes a wireless communication device (for example, a data communication module (DCM)) that can access a mobile communication network (telematics). The communication device 130 communicates with the server 500 via the mobile communication network. The wireless communicator may include a communication I/F compatible with fifth-generation mobile communication system (5G). In addition, the communication device 130 includes a communication I/F for directly communicating with the mobile terminals UT1, UT2 present in the vehicle or in a range around the vehicle. The communication device 130 and the mobile terminals UT1, UT2 may execute short-range communication, such as wireless local area network (LAN), near field communication (NFC), or Bluetooth (registered trademark).

The mobile terminals UT1, UT2 are terminals carried by a first user and a second user of the vehicle 1, respectively. In the present embodiment, a smartphone equipped with a touch panel display is adopted as the mobile terminals UT1, UT2. Each of the mobile terminals UT1, UT2 has a built-in position sensor that detects a current position of the terminal. The position sensor may be a sensor using a global positioning system (GPS). It should be noted that any mobile terminal can be adopted as each of the mobile terminals UT1, UT2, and a laptop, a tablet terminal, a wearable device (for example, a smartwatch or smart glasses), an electronic key, or the like can also be adopted.

The vehicle 1 can be adopted as one of the components of a mobility-as-a-service (MaaS) system. The MaaS system includes, for example, a mobility service platform (MSPF). The MSPF is a unified platform to which various mobility services (for example, various mobility services provided by a ride sharing business operator, a car sharing business operator, an insurance company, a car rental business operator, a taxi business operator, and the like) are connected. The server 500 is a computer that manages and opens information for the mobility services in the MSPF. The server 500 manages various types of mobility information, and provides information (for example, the API and information on cooperation between mobility) in response to a request from the business operator. The business operator that provides the service can use various functions provided by the MSPF by using the API open on the MSPF. For example, the API needed for the development of the ADK is open on the MSPF.

FIG. 2 is a diagram showing details of the configuration of the vehicle 1. With reference to FIG. 2 together with FIG. 1, the ADK 200 includes an autonomous driving system (hereinafter, referred to as “ADS”) 202 for executing autonomous driving of the vehicle 1. The ADS 202 includes a computer 210, a human machine interface (HMI) 230, a recognition sensor 260, a posture sensor 270, and a sensor cleaner 290.

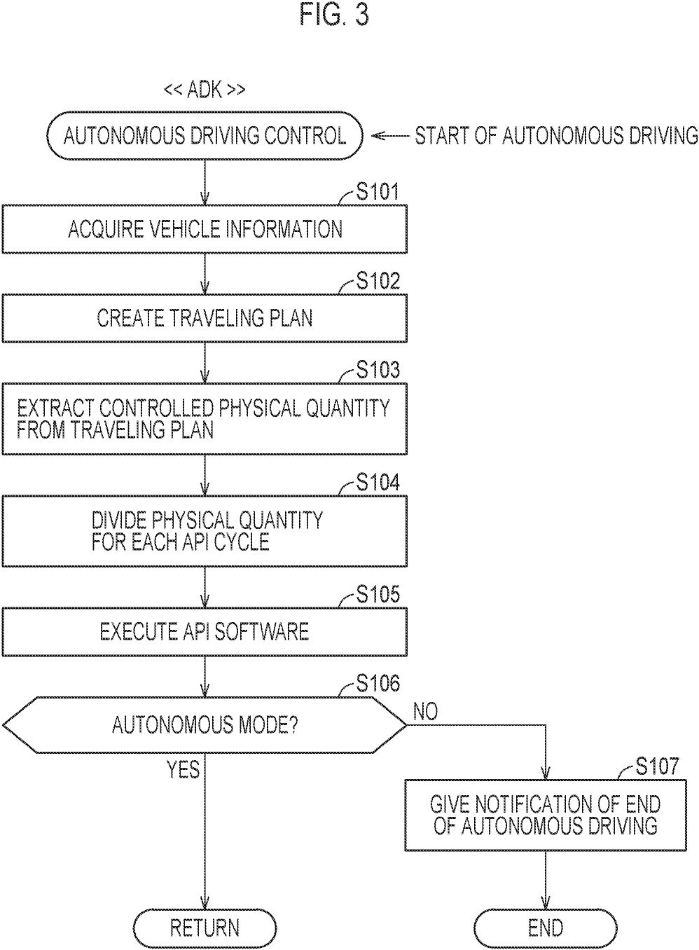

The computer 210 includes a processor and a storage device that stores autonomous driving software using the API, and is configured to execute the autonomous driving software by the processor. The autonomous driving software executes control related to autonomous driving (see FIG. 3 described below). The autonomous driving software may be updated sequentially by over the air (OTA). The computer 210 further includes communication modules 210A, 210B.

The HMI 230 is a device for exchanging information between the user and the computer 210. The HMI 230 includes an input device and a notification device. Through the HMI 230, the user can make an instruction or a request to the computer 210 or change a value of a parameter used in the autonomous driving software (it should be noted that the change is limited to a parameter that is allowed to be changed). The HMI 230 may be a touch panel display having both functions of the input device and the notification device.

The recognition sensor 260 includes various sensors that acquire information for recognizing an external environment of the vehicle 1 (hereinafter, also referred to as “environmental information”). The recognition sensor 260 acquires the environmental information of the vehicle 1 and outputs the acquired environmental information to the computer 210. The environmental information is used for the autonomous driving control. In the present embodiment, the recognition sensor 260 includes a camera that images the surroundings (including the front and rear) of the vehicle 1 and an obstacle detector (for example, a millimeter wave radar and/or a LiDAR) that detects an obstacle by electromagnetic waves or sound waves. For example, the computer 210 can recognize a person present in a range that can be recognized by the vehicle 1, an object (other vehicles, a pillar, a guardrail, or the like), and a line on a road (for example, a center line) by using the environmental information received from the recognition sensor 260. Artificial intelligence (AI) or an image processing processor may be used for recognition.

The posture sensor 270 acquires information related to a posture of the vehicle 1 (hereinafter, also referred to as “posture information”) and outputs the acquired information to the computer 210. The posture sensor 270 includes various sensors that detect the acceleration, the angular velocity, and the position of the vehicle 1. In the present embodiment, the posture sensor 270 includes an inertial measurement unit (IMU) and a GPS sensor. The IMU detects the acceleration of each of a front-rear direction, a right-left direction, and an up-down direction of the vehicle 1, and the angular velocity of each of a roll direction, a pitch direction, and a yaw direction of the vehicle 1. The GPS sensor detects the position of the vehicle 1 by using signals received from a plurality of GPS satellites. A technique of measuring the posture with high accuracy by combining the IMU and the GPS is known in a field of an automobile and an aircraft. The computer 210 may measure the posture of the vehicle 1 from the posture information described above by using, for example, such a known technique.

The sensor cleaner 290 is a device that removes dirt from the sensor (for example, the recognition sensor 260) that is exposed to the outside air outside the vehicle. For example, the sensor cleaner 290 may be configured to use a cleaning solution and the windshield wiper to clean a lens of the camera and an exit of the obstacle detector.

In the vehicle 1, in order to improve the safety, predetermined functions (for example, braking, steering, and vehicle fixing) are provided with redundancy. A control system 102 of the base vehicle 100 includes a plurality of systems that realizes equivalent functions. Specifically, the brake system 121 includes brake systems 121A, 121B. The steering system 122 includes steering systems 122A, 122B. The powertrain system 123 includes an EPB system 123A and a P-Lock system 123B. Each system includes an ECU. Even in a case where the abnormality occurs in one of the systems that realize the equivalent functions, the other of the systems is operated normally, so that the function works normally in the vehicle 1.

The VCIB 111 includes a VCIB 111A and a VCIB 111B. Each of the VCIBs 111A, 111B includes a computer. The communication modules 210A, 210B of the computer 210 are configured to communicate with the computers of the VCIBs 111A, 111B, respectively. The VCIB 111A and the VCIB 111B are connected to each other to be communicable with each other. Each of the VCIBs 111A, 111B can be operated independently, and even in a case where the abnormality occurs in one of the VCIBs 111A, 111B, the other of the VCIBs 111A, 111B is operated normally, so that the VCIB 111 is operated normally. Both the VCIBs 111A, 111B are connected to each of the systems described above via the integrity control manager 115. It should be noted that, as shown in FIG. 2, connection destinations of the VCIB 111A and the VCIB 111B are partially different.

In the present embodiment, a function of accelerating the vehicle 1 is not provided with redundancy. The powertrain system 123 includes a propulsion system 123C as a system for accelerating the vehicle 1.

The vehicle 1 is configured to switch between the autonomous mode and the manual mode. The API signal received by the ADK 200 from the VCIB 111 includes a signal indicating whether the vehicle 1 is in the autonomous mode or the manual mode (hereinafter, referred to as “autonomous state”). The user can select any of the autonomous mode and the manual mode through a predetermined input device (for example, the HMI 230 or the mobile terminals UT1, UT2). In a case where any of the driving modes is selected by the user, the vehicle 1 is set to the selected driving mode, and the selection result is reflected in the autonomous state. It should be noted that, in a case where the vehicle 1 is not in a state in which autonomous driving can be executed, the driving mode does not shift to the autonomous mode even when the user selects the autonomous mode. Switching of the driving modes of the vehicle 1 may be executed by the integrity control manager 115. The integrity control manager 115 may switch between the autonomous mode and the manual mode in accordance with a status of the vehicle 1.

In a case where the vehicle 1 is in the autonomous mode, the computer 210 acquires a state of the vehicle 1 from the VP 2 and sets a next operation of the vehicle 1 (for example, acceleration, deceleration, and turning). Moreover, the computer 210 outputs various commands for realizing the next set operation of the vehicle 1. In a case where the computer 210 executes the API software (that is, the autonomous driving software using the API), the command related to the autonomous driving control is transmitted from the ADK 200 to the integrity control manager 115 through the VCIB 111.

FIG. 3 is a flowchart showing processing executed by the ADK 200 in the autonomous driving control according to the present embodiment. The processing shown in this flowchart is repeatedly executed in a cycle corresponding to the API (API cycle) in a case where the vehicle 1 is in the autonomous mode. In a case where the driving mode of the vehicle 1 is switched from the manual mode to the autonomous mode, a start signal indicating the start of autonomous driving is transmitted from the vehicle 1 (communication device 130) to the server 500 together with the identification information of the vehicle 1, and a series of processing shown in FIG. 3 described below is started. In the following, each step in the flowchart is simply referred to as “S”.

With reference to FIG. 3 together with FIGS. 1 and 2, in S101, the computer 210 acquires the current information of the vehicle 1. For example, the computer 210 acquires the environmental information and the posture information of the vehicle 1 from the recognition sensor 260 and the posture sensor 270. Further, the computer 210 acquires the API signal. In the present embodiment, the API signal indicating the state of the vehicle 1 is sequentially output from the VCIB 111 to the ADK 200 in real time regardless of whether the vehicle 1 is in any of the autonomous mode and the manual mode. In order to improve the accuracy of the autonomous driving control, the state of the vehicle 1 may be sequentially transmitted from the integrity control manager 115 to the ADK 200 in a shorter cycle in the autonomous mode than in the manual mode. The API signal acquired by the computer 210 includes, in addition to the autonomous state described above, signals indicating the rotation direction and the rotation speed of each wheel detected by the wheel speed sensors 127A, 127B.

In S102, the computer 210 creates the traveling plan based on the information of the vehicle 1 acquired in S101. For example, the computer 210 calculates the behavior of the vehicle 1 (for example, the posture of the vehicle 1) and creates the traveling plan suitable for the state of the vehicle 1 and the external environment. The traveling plan is data indicating the behavior of the vehicle 1 in a predetermined period. In a case where the traveling plan is already present, the traveling plan may be amended in S102.

In S103, the computer 210 extracts a controlled physical quantity (acceleration, tire turning angle, or the like) from the traveling plan created in S102. In S104, the computer 210 divides the physical quantity extracted in S103 for each API cycle. In S105, the computer 210 executes the API software by using the physical quantity divided in S104. By executing the API software in this way, the API command (propulsion direction command, propulsion command, braking command, vehicle fixing command, or the like) requesting control to realize the physical quantity in accordance with the traveling plan is transmitted from the ADK 200 to the VCIB 111. The VCIB 111 transmits the control command corresponding to the received API command to the integrity control manager 115, and the integrity control manager 115 executes the autonomous driving control of the vehicle 1 in response to the control command. The state of the vehicle 1 during autonomous driving is sequentially recorded in the storage device of the computer 210.

In following S106, the computer 210 determines whether or not the vehicle 1 is in the autonomous mode. While the autonomous mode is maintained (YES in S106), autonomous driving of the vehicle 1 is executed by repeatedly executing the processing of S101 to S105. On the other hand, in a case where the vehicle 1 is in the manual mode (NO in S106), in S107, an end signal indicating the end of autonomous driving is transmitted from the vehicle 1 (communication device 130) to the server 500 together with the identification information of the vehicle 1, and then the series of processing shown in FIG. 3 ends. In the present embodiment, the computer 210, the VCIB 111, and the integrity control manager 115 cooperate to execute control to cause the vehicle 1 to travel by autonomous driving. The vehicle 1 can be autonomously driven in any of a manned or unmanned state. It should be noted that the autonomous driving control is not limited to the control shown in FIG. 3, and other controls (known autonomous driving control) may be adopted.

FIG. 4 is a diagram for describing various components provided in the vehicle 1. With reference to FIG. 4 together with FIGS. 1 and 2, the vehicle 1 further includes a battery 160 and a suspension 170. The propulsion system 123C includes a motor generator (MG) 20, an ECU 21, and a power control unit (PCU) 22. The battery 160 supplies electric power to the propulsion system 123C. As the battery 160, a known vehicle power storage device (for example, a liquid secondary battery, an all-solid-state secondary battery, or an assembled battery) can be adopted. Examples of the vehicle secondary battery include a lithium ion battery and a nickel-metal hydride battery. The suspension 170 may be an air suspension device.

The battery 160 includes a monitoring module 160a. The monitoring module 160a includes various sensors that detect a state of the battery 160 (for example, a voltage, a current, and a temperature), and outputs the detection result to the integrity control manager 115. The monitoring module 160a may be a battery management system (BMS) further having a state-of-charge (SOC) estimation function in addition to the sensor function. The control device 150 can acquire the state of the battery 160 (for example, the temperature, the current, the voltage, and the SOC) based on the output of the monitoring module 160a. The SOC indicates a remaining power storage amount, and for example, a ratio of a current power storage amount to a power storage amount in a fully charged state is represented by 0% to 100%.

The propulsion system 123C generates a traveling driving force of the vehicle 1 by using the electric power stored in the battery 160. For example, the MG 20 is a three-phase alternating current motor generator. The PCU 22 includes, for example, an inverter, a converter, and a relay (hereinafter, referred to as “system main relay (SMR)”). The PCU 22 is controlled by the ECU 21. The SMR is configured to switch connection/disconnection of a power path from the battery 160 to the MG 20. The SMR is put into a closed state (connected state) when the vehicle 1 travels.

The MG 20 is driven by the PCU 22 and rotates a drive wheel W of the vehicle 1. In addition, the MG 20 executes regenerative power generation, and supply the generated electric power to the battery 160. The PCU 22 drives the MG 20 by using the electric power supplied from the battery 160. The number of traveling motors (MGs 20) provided in the vehicle 1 is optional, and may be one, two, or three or more. The traveling motor may be an in-wheel motor. Although solely one drive wheel W is schematically shown in FIG. 4, the number of the drive wheels W and a drive method in the vehicle 1 are optional. The drive method of the vehicle 1 may be any of front-wheel drive, rear-wheel drive, and four-wheel drive.

Each wheel (including the drive wheel W) provided in the vehicle 1 includes a braking device 180 provided in the brake system 121 (FIG. 1), and a brake sensor 180a that detects the braking force applied to the wheel by the braking device 180. The brake sensor 180a may be a hydraulic sensor that detects a hydraulic pressure applied to a brake pad (or a wheel cylinder). The braking force (for example, the hydraulic pressure corresponding to the braking force) for each wheel detected by the four brake sensors 180a are output to the integrity control manager 115.

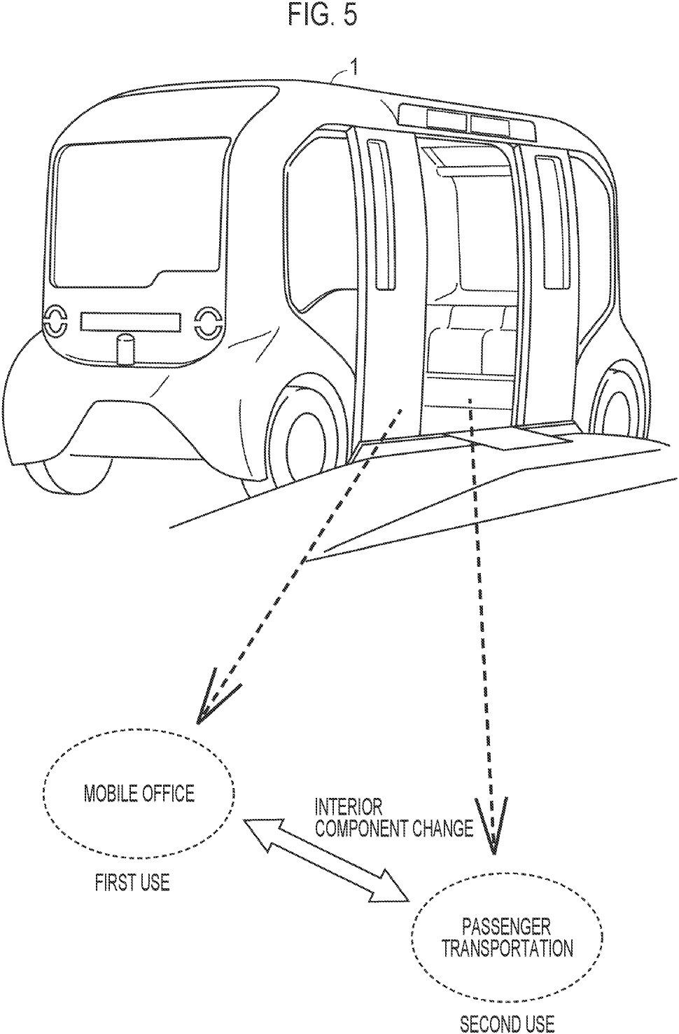

FIG. 5 is a diagram showing an appearance of the vehicle 1. With reference to FIG. 5, the vehicle 1 is a multipurpose vehicle configured to be customized in accordance with a use of the user by changing an interior component. With such a multipurpose vehicle, it is easy to provide each user with a vehicle having equipment that meets the needs of each user. In the present embodiment, a car sharing system is constructed by the vehicle 1 and the server 500. The vehicle 1 is shared between the first user and the second user.

The vehicle 1 according to the present embodiment is configured to be customized for each of a mobile office use (first use) and a passenger transportation use (second use). In the present embodiment, a common interior component used for both the first use and the second use is also simply referred to as “common interior component”. In addition, among the first and second uses, a use-specific interior component used solely for the first use is also referred to as “first use interior component”, and a use-specific interior component used solely for the second use is also referred to as a “second use interior component”.

In a first usage period, the first user uses the vehicle 1 for the mobile office use (first use). In a second usage period set after the first usage period, the second user uses the vehicle 1 for the passenger transportation use (second use). The vehicle 1 may be autonomously driven during at least one of the first usage period and the second usage period. During autonomous driving of the vehicle 1, the processing shown in FIG. 3 is executed, and the control device 150 controls various systems (for example, the brake system 121, the steering system 122, the powertrain system 123, the active safety system 125, and the body system 126 shown in FIG. 2) of the vehicle 1 in response to the command from the ADK 200.

In the present embodiment, the vehicle 1 is used daily. The vehicle 1 is used from morning until night. At night, the usage of the vehicle 1 on that day ends, and the component check of the vehicle 1 is executed. In the component check, whether or not the vehicle 1 has the performance equal to or greater than a predetermined standard by an objective inspection in accordance with a predetermined procedure is checked for each target component (inspection item). In the component check, the control device 150 may determine a pass or a fail for each target component based on the outputs of various sensors mounted on the vehicle 1. Alternatively, the component check may be executed using inspection equipment (tester).

In a case where no abnormality is found in any of the target components in the component check, the battery 160 (power storage device) of the vehicle 1 is charged using electric vehicle supply equipment (EVSE). By this charging, the electric power for the next usage is stored in the vehicle 1. A charging method of the EVSE may be a contact method or a non-contact method. Charging of the battery 160 is started after the end of the usage of the vehicle 1 and is completed by the morning of the day after the usage day. In the morning, the next usage of vehicle 1 is started.

In the present embodiment, the first usage period and the second usage period are reset each time one week elapses. The first user and the second user alternately use the vehicle 1 in a predetermined car sharing period. The car sharing period may be optionally set (or updated) and may be one month or one year.

A handover period for handing over the vehicle 1 may be provided between the usage periods. For example, a first handover period for handing over the vehicle 1 from the first user to the second user may be provided between the end of the first usage period and the start of the second usage period. In addition, a second handover period for handing over the vehicle 1 from the second user to the first user may be provided between the end of the second usage period and the start of the first usage period.

The first handover period may be set to at least a part from the evening of a last day of the first usage period to the afternoon of a first day of the second usage period. During the first handover period, the vehicle 1 may execute autonomous driving to be moved to a place designated by the second user. The server 500 may transmit, to the mobile terminal UT1, a signal for requesting the first user to complete the charging of the vehicle 1 for autonomous driving by the start time of the first handover period.

The second handover period may be set to at least a part from the evening of a last day of the second usage period to the afternoon of a first day of the first usage period. During the second handover period, the vehicle 1 may execute autonomous driving to be moved to a place designated by the first user. The server 500 may transmit, to the mobile terminal UT2, a signal for requesting the second user to complete the charging of the vehicle 1 for autonomous driving by the start time of the second handover period.

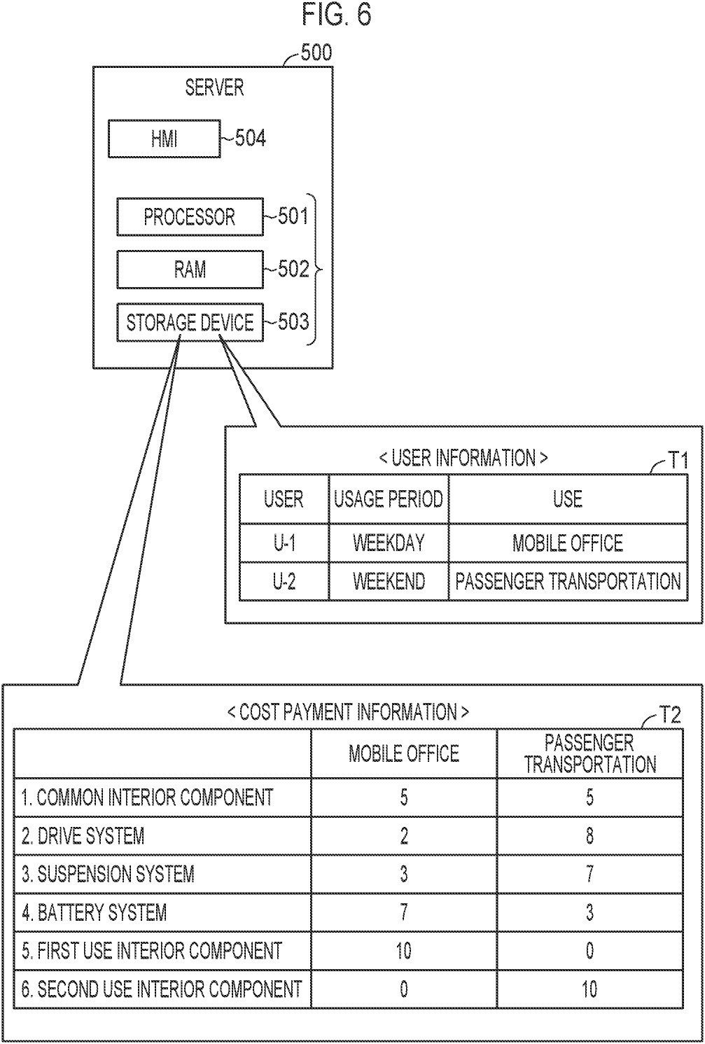

FIG. 6 is a diagram for describing a configuration of the server 500. With reference to FIG. 6 together with FIGS. 1 and 2, the server 500 includes a processor 501, a RAM 502, a storage device 503, and an HMI 504. A human machine interface (HMI) 504 includes an input device and a display device. The HMI 504 may be a touch panel display. The HMI 504 may include a smart speaker that receives a voice input. The server 500 is configured to communicate with each of the vehicle 1 and the mobile terminals UT1, UT2. Positional information (information indicating the current position of the vehicle 1) acquired by the posture sensor 270 of the vehicle 1 is sequentially transmitted from the vehicle 1 to the server 500. In addition, information indicating the current positions of the mobile terminals UT1, UT2 is also sequentially transmitted from each terminal to the server 500. The server 500 according to the present embodiment corresponds to an example of a “computer” according to the present disclosure.

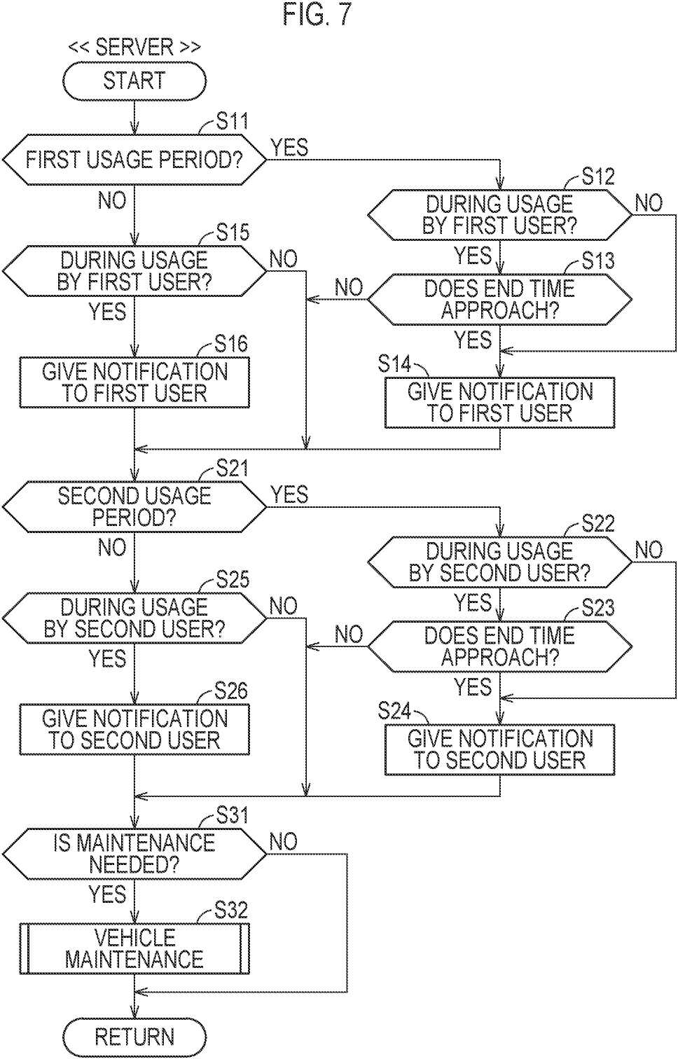

The storage device 503 is configured to store the stored information. The storage device 503 stores information related to each of the first user and the second user, and information related to the vehicle 1. For example, the information (for example, the positional information) received by the server 500 from each of the vehicle 1 and the mobile terminals UT1, UT2 is stored in the storage device 503. Further, the storage device 503 stores a program, and information used in the program (for example, a map, a mathematical formula, and various parameters). In the present embodiment, the processor 501 executes the program stored in the storage device 503, so that processing related to the vehicle management described below (see FIG. 7) is executed. It should be noted that such processing may be executed by dedicated hardware (electronic circuit) instead of software.

The server 500 manages information related to the user (hereinafter, referred to as “user information”) and information related to the cost (hereinafter, referred to as “cost payment information”). The user information and the cost payment information are stored in the storage device 503.

The user information is shown by Table T1 in FIG. 6. In the user information, the information of each user is distinguished by the identification information (user ID) for identifying the user. In Table T1, “U-1” and “U-2” correspond to the user IDs of the first user and the second user, respectively. The user information indicates a usage period of the vehicle 1 (that is, the first usage period and the second usage period described above) and the use of the vehicle 1 (that is, the first use and the second use described above), for each of the first user and the second user. In the present embodiment, the first use and the second use are the mobile office use and the passenger transportation use, respectively. In addition, the first usage period is a weekday (Monday to Friday), and the second usage period is a weekend (Saturday and Sunday). A usage time of the vehicle 1 by the first user is five days/week, and a usage time of the vehicle 1 by the second user is two days/week. As described above, the usage time of the vehicle 1 for each user is indicated by the user information. In the present embodiment, a unit period is one week, but a unit period is optional.

In the present embodiment, the cost payment information indicates a relationship between a plurality of component categories, a plurality of use categories, and a cost payment ratio as described below. The cost payment information is shown by Table T2 in FIG. 6.

The component categories defined by the cost payment information include a first component category related to the common interior component, a second component category related to a drive system component, a third component category related to the suspension 170, a fourth component category related to the battery 160, a fifth component category related to the first use interior component, and a sixth component category related to the second use interior component.

The drive system component includes various components for causing the vehicle 1 to travel. In addition to the component that gives power to the vehicle 1 (for example, the MG 20), a component that controls the travel of the vehicle 1 is also included in the drive system component. For example, the component provided in each of the ADK 200, the brake system 121, the steering system 122, and the propulsion system 123C corresponds to the drive system component. The first use interior component is, for example, an office product. The second use interior component is, for example, a passenger transport sheet.

The use categories defined by the cost payment information include the first use category related to the office use and the second use category related to the passenger transportation use. That is, the use of the first user (first use) belongs to the first use category, and the use of the second user (second use) belongs to the second use category.

The cost payment ratio indicated by the cost payment information is a payment ratio of each user for the cost of component maintenance. Examples of the component maintenance include repair or replacement of the component. In the present embodiment, the cost payment information indicates the cost payment ratio between the user having the office use (first user) and the user having the passenger transportation use (second user). Specifically, the cost payment ratio (first user: second user) indicated by the cost payment information is, as shown in Table T2 in FIG. 6, “5:5” for the first component category, “2:8” for the second component category, “3:7” for the third component category, “7:3” for the fourth component category, “10:0” for the fifth component category, and “0:10” for the sixth component category.

The cost payment ratio described above is decided in accordance with a deterioration tendency of the component. For example, in a case where the passenger transportation use and the office use are compared, each of the drive system component and the suspension-related component tends to be more easily deteriorated in the passenger transportation use, and the component of the power storage device tends to be more easily deteriorated in the office use. Since the use-specific interior component is solely used for the corresponding use, all the costs of the maintenance of the use-specific interior component is paid by the user who uses the vehicle 1 for the corresponding use.

The server 500 is configured to decide the payment ratio of each user for the cost of the maintenance based on a kind of the component subjected to the maintenance and a usage mode of the vehicle of each user in a case where the maintenance of the component is executed in one vehicle used by the users.

Specifically, with reference to the cost payment information (Table T2 in FIG. 6) described above, the server 500 (more specifically, the processor 501) acquires the cost payment ratio of each user from the component category to which the kind of the component subjected to the maintenance belongs among the first to sixth component categories, and the use category to which the use of the vehicle 1 of the first user belongs (first use category) and the use category to which the use of the vehicle 1 of the second user belongs (second use category) among the first to second use categories, and decides the payment ratio of each user for the cost of the component maintenance by using the acquired cost payment ratio of each user.

In the present embodiment, the server 500 (more specifically, the processor 501) decides the payment ratio of each user for the cost of the component maintenance by further using the usage time of the vehicle 1 of each user indicated by the user information (Table T1 in FIG. 6) described above, in addition to the cost payment ratio (hereinafter, also referred to as “first ratio”) of each user indicated by the cost payment information described above. The user information indicates a ratio of the usage time between the first user and the second user (hereinafter, also referred to as “second ratio”). In the present embodiment, the second ratio (first user: second user) is 5:2. The server 500 decides the payment ratio of each of the first user and the second user based on the first ratio and the second ratio. The server 500 increases the payment ratio of the user who uses the vehicle 1 for a long usage time.

FIG. 7 is a flowchart showing processing executed by the server 500 for managing the vehicle 1 shared between the first user and the second user. The processing shown in this flowchart is repeatedly executed during the car sharing period by the first user and the second user.

With reference to FIG. 7 together with FIGS. 1 to 6, in S11, the server 500 determines whether or not the current time is within the first usage period. In a case where the current time is within the first usage period (YES in S11), the processing proceeds to S12. In S12, the server 500 acquires a usage status of the vehicle 1 and determines whether or not the vehicle 1 is used by the first user.

In the present embodiment, the server 500 acquires the usage status of the vehicle 1 by using at least one of the current position of the vehicle 1, the current position of the mobile terminal UT1, and the current position of the mobile terminal UT2. For example, in a case where the vehicle 1 is present in the vicinity of the current position of the mobile terminal UT1, the server 500 determines that the vehicle 1 is used by the first user. In addition, in a case where the vehicle 1 is present in the vicinity of the current position of the mobile terminal UT2, the server 500 determines that the vehicle 1 is used by the second user. Moreover, in a case where the vehicle 1 is not present in the vicinity of any of the mobile terminals, the server 500 determines that the vehicle 1 is in an unused state (the vehicle 1 is not used by any user).

It should be noted that the determination method of the usage status of the vehicle 1 is not limited to the above, and can be changed as appropriate. For example, in a case where the vehicle 1 is present in an area used by the first user (for example, in the vicinity of home or work of the first user), the server 500 may determine that the vehicle 1 is used by the first user. In addition, in a case where the vehicle 1 is present in an area used by the second user (for example, in the vicinity of home or work of the second user), the server 500 may determine that the vehicle 1 is used by the second user. Moreover, in a case where the vehicle 1 is present outside the area used by each user, the server 500 may determine that the vehicle 1 is in the unused state.

In a case where the vehicle 1 is used by the first user (YES in S12), the server 500 determines in S13 whether or not an end time of the first usage period approaches. The end time of the first usage period may be the evening of the last day of the first usage period (for example, 17:00). The server 500 may determine in S13 whether or not a predetermined time on the last day of the first usage period has passed. The predetermined time may be a time (for example, 16:00) that goes back from the end time of the first usage period by a predetermined time. On the other hand, in a case where the vehicle 1 is in the unused state, or in a case where the vehicle 1 is used by the second user, the server 500 determines NO in S12. In a case where the server 500 determines NO in S12 or YES in S13, the processing proceeds to S14.

In S14, the server 500 gives a notification to the first user. The server 500 gives the notification to, for example, the mobile terminal UT1. In a case where the vehicle 1 is used by the first user (YES in S12) and the end time of the first usage period approaches (YES in S13), the server 500 requests the first user to prepare to hand over the vehicle 1 to the second user by the notification of S14. In a case where the vehicle 1 is in the unused state, the server 500 prompts the first user to use the vehicle 1 by the notification of S14. In a case where the vehicle 1 is used by the second user (YES in S25 described below), the server 500 notifies the first user of the usage status of the vehicle 1 by the notification of S14. In a case where the status of the second user is received from the mobile terminal UT2 by the processing of S26 described below, the server 500 notifies the first user of the status of the second user by the notification of S14.

In a case where the processing of S14 is executed, the processing proceeds to S21. In addition, in a case where the vehicle 1 is used by the first user (YES in S12) and there is enough time to the end time of the first usage period (NO in S13), the processing proceeds to S21 without making the notification to the first user (S14).

In a case where the current time is outside the first usage period (NO in S11), the processing proceeds to S15. In S15, as in S12, the server 500 acquires the usage status of the vehicle 1, and determines whether or not the vehicle 1 is used by the first user. Moreover, in a case where the vehicle 1 is used by the first user (YES in S15), the processing proceeds to S16.

In S16, the server 500 gives a notification to the first user. The server 500 gives the notification to, for example, the mobile terminal UT1. The server 500 requests the first user to hand over the vehicle 1 to the second user by the notification of S16. In addition, the server 500 requests the first user to return the status of each of the vehicle 1 and the first user by the notification of S16.

In a case where the processing of S16 is executed, the processing proceeds to S21. In addition, in a case where the current time is outside the first usage period (NO in S11) and the vehicle 1 is not used by the first user (NO in S15), the processing proceeds to S21 without making the notification to the first user (S16).

In S21, the server 500 determines whether or not the current time is within the second usage period. In a case where the current time is within the second usage period (YES in S21), the processing proceeds to S22. In S22, the server 500 acquires a usage status of the vehicle 1 and determines whether or not the vehicle 1 is used by the second user.

In a case where the vehicle 1 is used by the second user (YES in S22), the server 500 determines in S23 whether or not an end time of the second usage period approaches. The end time of the second usage period may be the evening of the last day of the second usage period (for example, 17:00). The server 500 may determine in S23 whether or not a predetermined time on the last day of the second usage period has passed. The predetermined time may be a time (for example, 16:00) that goes back from the end time of the second usage period by a predetermined time. On the other hand, in a case where the vehicle 1 is in the unused state, or in a case where the vehicle 1 is used by the first user, the server 500 determines NO in S22. In a case where the server 500 determines NO in S22 or YES in S23, the processing proceeds to S24.

In S24, the server 500 gives a notification to the second user. The server 500 gives the notification to, for example, the mobile terminal UT2. In a case where the vehicle 1 is used by the first user (YES in S22) and the end time of the second usage period approaches (YES in S23), the server 500 requests the second user to prepare to hand over the vehicle 1 to the second user by the notification of S24. In a case where the vehicle 1 is in the unused state, the server 500 prompts the second user to use the vehicle 1 by the notification of S24. In a case where the vehicle 1 is used by the first user (YES in S15), the server 500 notifies the second user of the usage status of the vehicle 1 by the notification of S24. In a case where the status of the first user is received from the mobile terminal UT1 by the processing of S16, the server 500 notifies the second user of the status of the first user by the notification of S24.

In a case where the processing of S24 is executed, the processing proceeds to S31. In addition, in a case where the vehicle 1 is used by the second user (YES in S22) and there is enough time to the end time of the second usage period (NO in S23), the processing proceeds to S31 without making the notification to the second user (S24).

In a case where the current time is outside the second usage period (NO in S21), the processing proceeds to S25. In S25, as in S22, the server 500 acquires the usage status of the vehicle 1, and determines whether or not the vehicle 1 is used by the second user. Moreover, in a case where the vehicle 1 is used by the second user (YES in S25), the processing proceeds to S26.

In S26, the server 500 gives a notification to the second user. The server 500 gives the notification to, for example, the mobile terminal UT2. The server 500 requests the second user to hand over the vehicle 1 to the first user by the notification of S26. In addition, the server 500 requests the second user to return the status of each of the vehicle 1 and the second user by the notification of S26.

In a case where the processing of S26 is executed, the processing proceeds to S31. In addition, in a case where the current time is outside the second usage period (NO in S21) and the vehicle 1 is not used by the second user (NO in S25), the processing proceeds to S31 without making the notification to the second user (S26).

In S31, the server 500 determines whether or not the maintenance of the vehicle 1 is needed. In the present embodiment, in a case where an abnormality is found in any of the components in the component check executed after the vehicle 1 is used (for example, at night), the server 500 determines YES in S31, and in a case where an abnormality is not found in any of the components, the server 500 determines NO in S31.

In a case where the server 500 determines that the maintenance of the vehicle 1 is needed (YES in S31), the server 500 executes the processing related to the maintenance of the vehicle 1 in S32. On the other hand, in a case where the server 500 determines that the maintenance of the vehicle 1 is not needed (NO in S31), a series of processing shown in FIG. 7 ends without executing the vehicle maintenance (S32), and the processing returns to first step (S11).

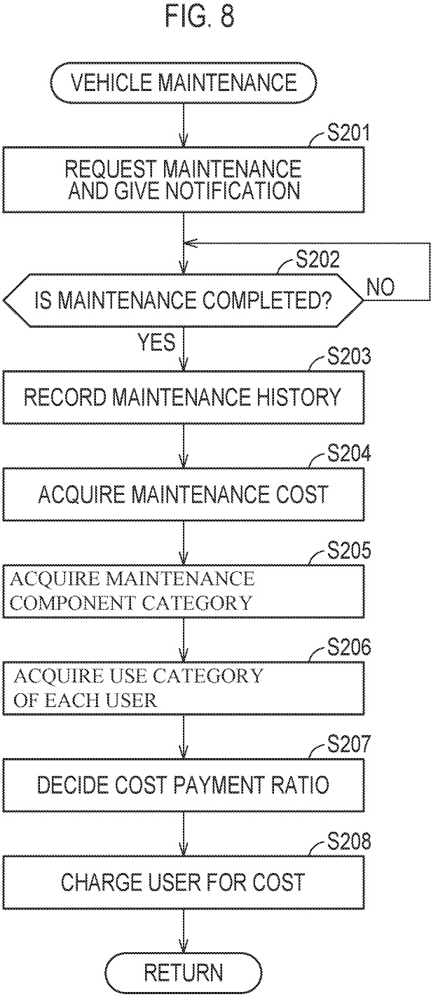

In S32, a series of processing shown in FIG. 8 described below is executed. FIG. 8 is a flowchart for describing the details of the processing related to the maintenance of the vehicle 1 executed by the server 500.

With reference to FIG. 8 together with FIGS. 1 to 6, in S201, the server 500 requests the maintenance and gives a notification for the component of the vehicle 1 in which the abnormality is found (see S31 in FIG. 7).

Specifically, the server 500 transmits a signal (hereinafter, also referred to as “request signal”) for requesting the maintenance (for example, repair or replacement) of the component of the vehicle 1 in which the abnormality is found, in S201. The server 500 may transmit the request signal to a terminal of a maintenance company. The server 500 may transmit the request signal to the mobile terminal UT1 or UT2 carried by the user who uses the vehicle 1. Moreover, the user who uses the vehicle 1 may request the maintenance company for the maintenance.

In addition, the server 500 causes a predetermined notification device (for example, the HMI 230) to execute notification processing of making a notification that the maintenance of the vehicle 1 is to be executed, in S201. The server 500 may cause each of the mobile terminals UT1, UT2 to execute the notification processing described above.

In following S202, the server 500 determines whether or not the maintenance requested in S201 is completed. Moreover, the server 500 waits until the maintenance is completed (NO in S202). During waiting, the server 500 may receive input of a maintenance result (history). The server 500 may determine whether or not the maintenance is completed based on whether or not the maintenance result is input to the server 500. In a case where the maintenance is completed (YES in S202), the server 500 records a maintenance history (for example, the date and time of the maintenance, the component subjected to the maintenance, and a content of the maintenance) in the storage device 503 in S203. The maintenance company may input the maintenance result (history) to the server 500 through the HMI 504.

In following S204, the server 500 acquires the cost of the maintenance (maintenance cost). The server 500 may receive the maintenance cost from the terminal of the maintenance company. Alternatively, the server 500 may obtain the maintenance cost based on a predetermined price list. The price list may be stored in the storage device 503 in advance.

In following S205, the server 500 acquires the component category (maintenance component category) to which the kind of the component subjected to the maintenance (for example, component repaired or replaced) belongs among the first to sixth component categories shown in Table T2 in FIG. 6.

In following S206, the server 500 acquires the use category to which the use of the vehicle 1 of each user belongs. In the present embodiment, the first use category is acquired as a use category of the first user (first user use category), and the second use category is acquired as a use category of the second user (second user use category).

In following S207, the server 500 decides the payment ratio of each user for the maintenance cost by using the maintenance component category acquired in S205, the use category of each user acquired in S206, the user information shown in Table T1 in FIG. 6, and the cost payment information shown in Table T2 in FIG. 6. Specifically, the server 500 acquires the first ratio (cost payment ratio of each user indicated by the cost payment information) from the maintenance component category acquired in S205, and the first and second user use categories acquired in S206. For example, in a case where the maintenance component category acquired in S205 is the second component category, the server 500 acquires “2:8” as the first ratio (first user: second user). In addition, the server 500 acquires “5:2” as the second ratio (first user: second user) indicated by the user information. Moreover, the server 500 obtains a ratio of “10:16 (= 5:8)” by multiplying the first ratio by the second ratio. The server 500 decides this calculation result (ratio “5: 8”) as a final cost payment ratio (first user: second user).

In the subsequent S208, the server 500 charges at least one of the first user and the second user for the maintenance cost based on the cost payment ratio of each user decided in S207. The server 500 notifies at least one of the mobile terminals UT1, UT2 of the cost charge, for example. For example, in a case where the maintenance cost acquired in S204 is 130,000 yen and the cost payment ratio (first user: second user) decided in S207 is “5:8”, the server 500 charges the first user for 50,000 yen by the notification described above to the mobile terminal UT1, and charges the second user for 80,000 yen by the notification described above to the mobile terminal UT2. Each user may pay the maintenance cost by cashless payment by operating the mobile terminal UT1 or UT2 in accordance with a guide of cashless payment. It should be noted that, in a case where the component subjected to the maintenance is the use-specific interior component, the server 500 charges solely one of the first user or the second user for the maintenance cost.

In a case where the processing of S208 is executed, a series of processing shown in FIG. 8 ends. Moreover, the processing returns to first step (S11) in FIG. 7.

As described above, the car sharing method according to the present embodiment includes the processing shown in each of FIGS. 7 and 8.

In the processing shown in FIG. 7, the server 500 executes first provision processing of providing the vehicle 1 to the first user (S11 to S14, S21, S25, and S26). In addition, after the first user uses the vehicle 1, the server 500 executes second provision processing of providing the vehicle 1 to the second user (S21 to S24, S11, S15, and S16).

The first provision processing includes prompting the first user to use the vehicle 1 via the server 500 (S14) in a case where the first user does not use the vehicle 1 within the first usage period (YES in S11 and NO in S12), and requesting the second user to hand over the vehicle 1 to the first user via the server 500 (S26) in a case where the second user uses the vehicle 1 within the first usage period (NO in S21 and YES in S25).

The second provision processing includes prompting the second user to use the vehicle 1 via the server 500 (S24) in a case where the second user does not use the vehicle 1 within the second usage period set after the first usage period (YES in S21 and NO in S22), and requesting the first user to hand over the vehicle 1 to the second user via the server 500 (S16) in a case where the first user uses the vehicle 1 within the second usage period (NO in S11 and YES in S15).

In the processing shown in FIG. 8, in a case where the maintenance of the component is executed in the vehicle 1, the server 500 executes processing (decision processing) of deciding the payment ratio of each user for the cost of the maintenance based on the kind of the component subjected to the maintenance and the usage mode of the vehicle 1 of each user (S205 to S207).

The decision processing includes acquiring the maintenance component category to which the kind of the component subjected to the maintenance belongs among the component categories indicated by the cost payment information (FIG. 6) via the server 500 (S205), acquiring the first user use category to which the use for the vehicle 1 of the first user belongs among the use categories indicated by the cost payment information (FIG. 6)via the server 500 (S206), acquiring the second user use category to which the use for the vehicle 1 of the second user belongs among the use categories indicated by the cost payment information (FIG. 6) via the server 500 (S206), acquiring the cost payment ratio between the first user and the second user via the server 500 by using the acquired maintenance component category, first user use category, and second user use category (S207), and deciding the payment ratio of each user for the cost of the maintenance via the server 500 by using the acquired cost payment ratio (S207).

With the car sharing method described above, it is possible to fairly decide the cost payment ratio of each user in a case where the maintenance of the component is executed in one vehicle shared by the users.

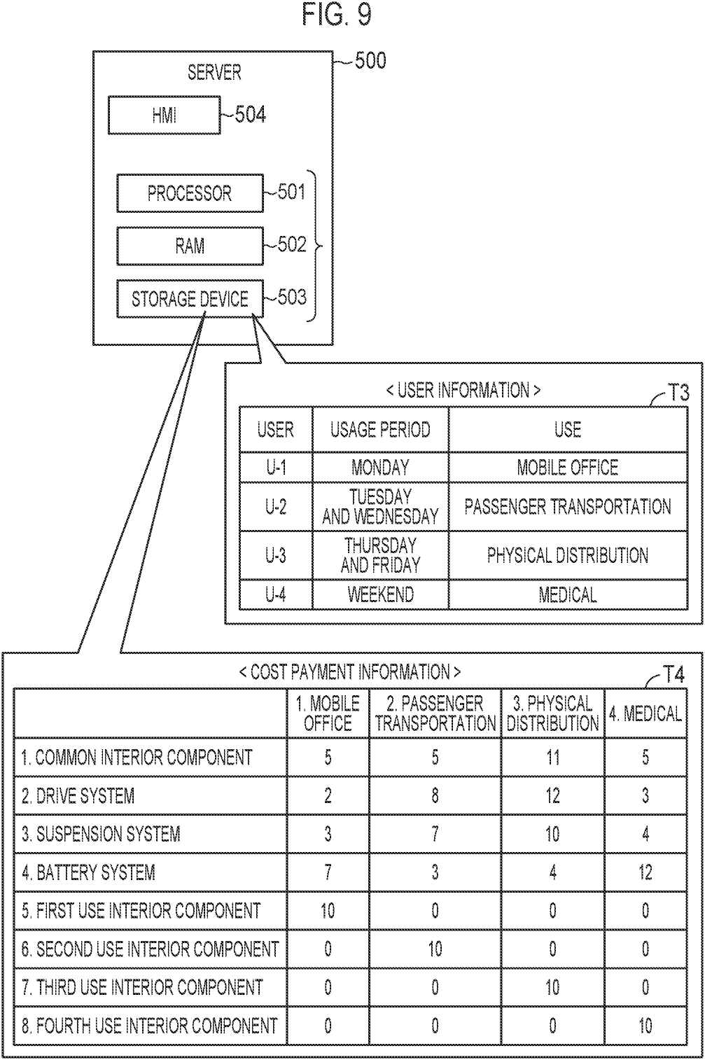

In the embodiment described above, one vehicle is shared by two users. However, the number of users in car sharing is not limited to this, and the number of users can be changed as appropriate, and may be three or more. Each of the user information and the cost payment information in the embodiment described above may be changed in accordance with a form of car sharing. FIG. 9 is a diagram showing a modification example of the user information and the cost payment information shown in FIG. 6.

The user information according to this modification example is shown by Table T3 in FIG. 9. In Table T3, “U-1”, “U-2”, “U-3”, and “U-4” correspond to the user IDs of the first user, the second user, a third user, and a fourth user, respectively. The user information indicates the usage period of the vehicle 1 (first to fourth usage periods) and the use of the vehicle 1 (first to fourth uses) for each of the first to fourth users. In the present embodiment, the first use, the second use, the third use, and the fourth use are the mobile office use, the passenger transportation use, the physical distribution use, and the medical use, respectively. In addition, the first usage period is Monday, the second usage period is Tuesday and Wednesday, the third usage period is Thursday and Friday, and the fourth usage period is weekend (Saturday and Sunday). The usage time of the vehicle 1 by the first user is one day/week, the usage time of the vehicle 1 by the second user is two days/week, the usage time of the vehicle 1 by the third user is two days/week, and the usage time of the vehicle 1 by the fourth user is two days/week. As described above, the usage time of the vehicle 1 for each user is indicated by the user information.

The cost payment information according to this modification example is shown by Table T4 in FIG. 9. The component categories defined by the cost payment information include the first component category related to the common interior component, the second component category related to the drive system component, the third component category related to the suspension 170, the fourth component category related to the battery 160, the fifth component category related to the first use interior component, the sixth component category related to the second use interior component, a seventh component category related to a third use interior component, and an eighth component category related to a fourth use interior component. It should be noted that the common interior component is the interior component used for all of the first to fourth uses.

The use categories defined by the cost payment information includes the first use category related to the office use, the second use category related to the passenger transportation use, the third use category related to the physical distribution use, and the fourth use category related to the medical use. That is, the use of the first user (first use) belongs to the first use category, the use of the second user (second use) belongs to the second use category, and the use of the third user (third use) belongs to the third use category, and the use of the fourth user (fourth use) belongs to the fourth use category.

In this modification example, the cost payment information indicates the cost payment ratio among the user having the office use (first user), the user having the passenger transportation use (second user), the user having the physical distribution use (third user), and the user having the medical use (fourth user). As shown in Table T4 in FIG. 9, this cost payment ratio is decided in accordance with the deterioration tendency of the component. For example, in a case where the passenger transportation use and the physical distribution use are compared, all of the interior component, the drive system component, the suspension-related component, and the component of the power storage device tend to be more easily deteriorated in the physical distribution use. In a case where the passenger transportation use and the medical use are compared, each of the drive system component and the suspension-related component tends to be more easily deteriorated in the passenger transportation use, and the component of the power storage device tends to be more easily deteriorated in the medical use. In a case where the office use and the medical use are compared, all of the drive system component, the suspension-related component, and the component of the power storage device tend to be more easily deteriorated in the medical use. All the costs of the maintenance of the use-specific interior component are paid by the user who uses the vehicle 1 for the corresponding use.

According to the user information and the cost payment information according to the modification example described above, in a case where the maintenance of the component is executed in one vehicle shared by the first to fourth users, the cost payment ratio among the first to fourth users can be decided fairly.

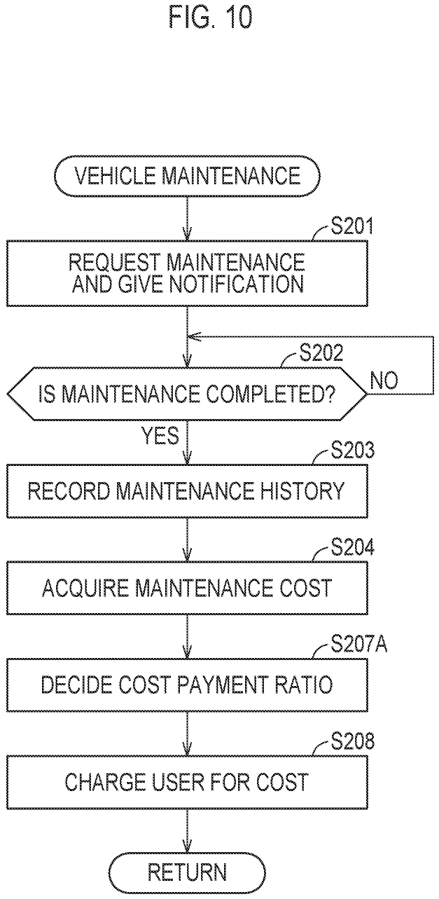

In the embodiment described above, in the decision processing (the processing of deciding the payment ratio of each user for the cost of the maintenance), the usage mode (more specifically, the use) of the vehicle 1 of each user is classified into any of the use categories indicated by the cost payment information (FIG. 9). However, it is not always needed to use the cost payment information in the decision processing. For example, the server 500 may execute a series of processing shown in FIG. 10 described below instead of the processing shown in FIG. 8.

FIG. 10 is a flowchart showing a modification example of the processing shown in FIG. 8. The processing shown in FIG. 10 corresponds to the processing shown in FIG. 8 except that S207A is adopted instead of S205 to S207 (FIG. 8). In the following, S207A will be described.

With reference to FIG. 10 together with FIGS. 1 to 6, in S207A, the server 500 decides the payment ratio of each user for the cost of the maintenance based on the usage mode of the vehicle 1 of each user. Specifically, the server 500 evaluates a degree of deterioration of the component subjected to the maintenance for the usage mode of each vehicle 1 of the first user and the second user. Moreover, the server 500 increases the cost payment ratio of the user who uses the vehicle 1 in a mode in which the component subjected to the maintenance is likely to be deteriorated (that is, the user who has a degree of deteriorating the component subjected to the maintenance).

The server 500 may receive the state of the vehicle 1 recorded during autonomous driving (see FIG. 3) from the vehicle 1. The server 500 may estimate a progress degree of deterioration of the component caused by the usage of the first user based on a transition of the state of the vehicle 1 detected by various sensors of the vehicle 1 in a case where the vehicle 1 is used by the first user. In addition, the server 500 may estimate a progress degree of deterioration of the component caused by the usage of the second user based on a transition of the state of the vehicle 1 detected by various sensors of the vehicle 1 in a case where the vehicle 1 is used by the second user. For example, as a frequency of sudden starts or sudden braking is higher, the drive system component is more easily deteriorated. In addition, as a charge and discharge frequency, the battery 160 is more easily deteriorated. The server 500 may estimate the progress degree of deterioration of the component caused by the usage of each user by further using the use of each user.

In the car sharing method according to the modification example described above, in a case where the maintenance of the component is executed in the vehicle 1, the server 500 acquires the progress degree of deterioration of the component caused by the usage of the vehicle 1 for each user, and decides the payment ratio of each user for the cost of the maintenance of the component by using the progress degree of deterioration of the component for each user (S207A). Even with such a car sharing method, it is possible to fairly decide the cost payment ratio of each user.

In the embodiment and the modification example described above, an on-premises server is adopted as the server 500 (see FIG. 1). However, the present disclosure is not limited to this, and cloud computing may implement at least a part of the functions of the server 500 on the cloud. In addition, at least a part of the functions of the server 500 may be implemented in the vehicle or the mobile terminal.

The configuration of the vehicle is not limited to the configuration described in the embodiment described above (see FIGS. 1, 2, 4, and 5). The base vehicle may have an autonomous driving function without retrofitting. A level of autonomous driving may be fully autonomous driving (level 5) or conditional autonomous driving (for example, level 4). The configuration of the vehicle may be changed to a configuration dedicated to unmanned traveling, as appropriate. For example, a vehicle dedicated to unmanned traveling does not have to include the component (steering wheel or the like) for a person to operate the vehicle. It should be noted that the vehicle to which the car sharing system and the car sharing method described above are applied is not limited to the autonomous driving vehicle.

The vehicle may include a solar panel or may have a flight function. The vehicle is not limited to a passenger car, and may be a bus or a truck. The vehicle may be a privately owned vehicle (POV). The vehicle may be a multipurpose vehicle customized in accordance with the user’s purpose of use. The vehicle may be a mobile store vehicle, an automated guided vehicle (AGV), or an agricultural machine. The vehicle may be an unmanned or one-passenger small BEV (for example, a Micro Pallet).

The embodiment and each modification example described above may be carried out in any combination.

The embodiment disclosed this time should be considered to be exemplary examples and not to be restrictive in all respects. The technical scope of the present disclosure is shown by the scope of claims rather than the description of the embodiment described above, and is intended to include all changes within the meaning and scope equivalent to the scope of claims.

What is claimed is:

1. A computer configured to, in a case where maintenance of a component is executed in one vehicle used by a plurality of users, decide a payment ratio of each user for a cost of the maintenance based on a kind of the component subj ected to the maintenance and a usage mode of the vehicle of each user.

2. The computer according to claim 1, comprising:
a processor; and
a storage device, wherein:
the storage device is configured to store cost payment information indicating a relationship between a plurality of component categories, a plurality of use categories, and a cost payment ratio; and
the processor is configured to
acquire the cost payment ratio of each user from a component category to which the kind of the component subjected to the maintenance belongs among the component categories and a use category to which a use for the vehicle of each user belongs among the use categories, and
decide the payment ratio of each user for the cost of the maintenance by using the acquired cost payment ratio of each user.

3. The computer according to claim 2, wherein:
the component categories include two or more component categories selected from the group consisting of a first component category related to an interior component, a second component category related to a drive system component, a third component category related to a suspension, and a fourth component category related to a power storage device; and
the use categories include two or more use categories selected from the group consisting of a first use category related to an office use, a second use category related to a passenger transportation use, a third use category related to a physical distribution use, and a fourth use category related to a medical use.

4. The computer according to claim 2, wherein:
the storage device is configured to further store user information indicating a usage time of the vehicle of each user; and
the processor is configured to decide the payment ratio of each user for the cost of the maintenance by further using the usage time of the vehicle of each user indicated by the user information in addition to the cost payment ratio of each user indicated by the cost payment information.

5. The computer according to claim 1, wherein the computer is configured to
in a case where the maintenance of the component is executed in the vehicle, acquire a progress degree of deterioration of the component caused by the usage of the vehicle for each user, and
decide the payment ratio of each user for the cost of the maintenance of the component by using the progress degree of deterioration of the component for each user.

6. A car sharing system comprising:
the computer according to claim 1; and
the vehicle shared by the users,
wherein the vehicle is a multipurpose vehicle configured to be customized in accordance with a use of the user by changing an interior component.

7. The car sharing system according to claim 6, wherein:
the vehicle includes
a control device,
an autonomous driving kit, and
a vehicle control interface configured to mediate exchange of signals between the control device and the autonomous driving kit;
the autonomous driving kit is configured to transmit a command for autonomous driving to the control device via the vehicle control interface;
the control device is configured to control the vehicle in accordance with the command from the autonomous driving kit; and
the control device is configured to transmit a signal indicating a state of the vehicle to the autonomous driving kit via the vehicle control interface.

8. A car sharing method comprising:
first provision processing of providing a vehicle to a first user via a computer;
second provision processing of providing the vehicle to a second user via the computer after the first user uses the vehicle; and
decision processing of deciding, in a case where maintenance of a component is executed in the vehicle, a payment ratio of each user for a cost of the maintenance via the computer based on a kind of the component subjected to the maintenance and a usage mode of the vehicle of each user.

9. The car sharing method according to claim 8, wherein:
the first provision processing includes
prompting the first user to use the vehicle via the computer in a case where the first user does not use the vehicle within a first usage period, and
requesting the second user to hand over the vehicle to the first user via the computer in a case where the second user uses the vehicle within the first usage period; and the second provision processing includes
prompting the second user to use the vehicle via the computer in a case where the second user does not use the vehicle within a second usage period set after the first usage period, and
requesting the first user to hand over the vehicle to the second user via the computer in a case where the first user uses the vehicle within the second usage period.

10. The car sharing method according to claim 8, wherein:
the computer includes a processor and a storage device;
the storage device is configured to store cost payment information indicating a relationship between a plurality of component categories, a plurality of use categories, and a cost payment ratio; and
the decision processing includes
acquiring a maintenance component category to which the kind of the component subjected to the maintenance belongs among the component categories via the computer,
acquiring a first user use category to which a use for the vehicle of the first user belongs among the use categories via the computer,
acquiring a second user use category to which a use for the vehicle of the second user belongs among the use categories via the computer,
acquiring the cost payment ratio between the first user and the second user via the computer by using the acquired maintenance component category, first user use category, and second user use category, and
deciding the payment ratio of each user for the cost of the maintenance via the computer by using the acquired cost payment ratio.

11. The car sharing method according to claim 10, wherein:
the component categories include two or more component categories selected from the group consisting of a first component category related to an interior component, a second component category related to a drive system component, a third component category related to a suspension, and a fourth component category related to a power storage device; and
the use categories include two or more use categories selected from the group consisting of a first use category related to an office use, a second use category related to a passenger transportation use, a third use category related to a physical distribution use, and a fourth use category related to a medical use.

12. The car sharing method according to claim 10, wherein:
the storage device is configured to further store user information indicating a usage time of the vehicle of each user; and
the processor is configured to decide the payment ratio of each user for the cost of the maintenance by further using the usage time of the vehicle of each user indicated by the user information in addition to the cost payment ratio of each user indicated by the cost payment information.
